(19) United States
(12) Patent Application Publication
(10) Pub. No.: US 2002/0011801 A1
(43) Pub. Date: Jan. 31, 2002

(54) Power feedback power factor correction scheme for multiple lamp operation

(76) Inventor: Chin Chang, Yorktown Heights, NY (US)

Correspondence Address: Corporate Patent Counsel, US Philips Corporation, 580 White Plains road, Tarrytown, NY, 10591, US

(21) Appl. No.: 09/489,753

(22) Filed: Jan. 21, 2000

(51) Int. Cl. H05B 37/02

(52) U.S. Cl. 315/219; 315/276; 315/224

(57) ABSTRACT

A ballast circuit for a single or multiple lamp parallel operation where at each lamp a condition may be controlled such that the amplitude of a resonant inductor current and an output voltage are almost constant in the steady state. The inventive circuit consists of a half-bridge of a DC storage capacitor, a DC blocking capacitor, power transistors which alternatively switch on and off and having 50% duty ratio, and an LLC resonant converter having a resonant inductor and one or more resonant capacitors. The inventive circuit consists of an output transformer providing galvanic isolation for a double path type power feedback scheme. The output transformer produces magnetizing inductance utilized for power feedback circuit optimization and is inserted right after the resonant inductor of the half-bridge circuit.

### BACKGROUND OF THE INVENTION

1. Field of the Invention

The invention relates to power feedback circuits. More particularly, the invention relates to a double path type power feedback scheme circuit for multiple lamp parallel operation.

2. Description of the Background of the Invention

The low power factor (PF) of conventional electromagnetic compact fluorescent lamps (CFLs) is due to the fact that their voltage and current are not in phase and/or to the higher harmonic content in current waveform. Electronics in the electronic CFLs, as well as in all other electronic equipment, generate harmonic currents. Harmonic currents are closely related to a reduced PF and can disturb other equipment. Furthermore, a very high harmonic distortion on a utility network may reduce the performance of the transformers and could ultimately damage them.

An electronic CFL has a typical power factor of between 0.5 and 0.6, but the current cannot be simply compensated for with a capacitor. Instead, a filter has to be introduced, either in the ballast of the lamp itself or somewhere in the electricity network. In countries where the International Electroctechnical Commission (IEC) standards are adopted, the lighting equipment must have a power factor better than 0.96 and a Total Harmonic Distortion (THD) below 33%. However an exception is made in the IEC lighting standards for equipment with a rated power of less than 25W.

The single stage electronic ballast based on the power feedback principles has been disclosed and described in numerous patents, including U.S. Pat. No. 5,404,082 in the names of A. F. Hernandez and G. W. Bruning, and entitled “High Frequency Inverter with Power-line-controlled Frequency Modulation,” and U.S. Pat. No. 5,410,221 in the names of C. B. Mattas and J. R Bergervoet, and entitled “Lamp Ballast with Frequency Modulated Lamp Frequency,”. The type of ballast described in these patents has a lower parts count due to a modulation scheme imbedded in a power conversion process. These patents describe the conversion of a low frequency alternating current (AC) voltage source to a high frequency AC voltage source via a properly designed power feedback scheme. These patents further describe how a harmonic content of an input current can be limited within the International Electrotechnical Commission (IEC) specification while the output current crest factor remains acceptable. Topologically, the single stage power factor correction is achieved based on the power feedback to the node between the full-bridge rectifier output and the DC eleco cap.

To date, all of the power feedback schemes are used for a single lamp and a two lamp series configurations, with and without dimming. It is important to point out that in such a class of applications the value of the resonant converter parameters L and C are fixed, even though the load current can be changed during the dimming process. Technically, this implies that the circuit resonant frequency is fixed while the quality factor (Q) is changed with the load. The quality factor Q may be described as the ratio of the resonant frequency to bandwidth.

In the multiple lamp operation circuit 10, shown in FIG. 1, lamps Rₗₚ are connected in parallel, via blasting capacitors Cₗₚ, respectively, due to the independent lamp operation (ILO) requirements. Lamps Rₗₚ and blasting capacitors Cₗₚ are then connected in parallel to a transformer T₁; which in turn is connected in parallel to a capacitor C₃. Capacitor C₃ is connected to diodes D₃, D₄ of the full-bridge rectifier represented by diodes D₁-D₄, and diodes D₁, D₂ are connected to a resonant inductor L₁, which in turn is connected to a diode D₅. Diode D₅ is further connected to a drain terminal of a positive-negative-positive (PNP) transistor Q₂, and the source terminal of transistor Q₂ is connected to a drain of a PNP transistor Q₃. Gates of both transistors Q₁ and Q₂ are connected to a high voltage control integrated circuit 12.

A first terminal of a resistor R₁ is connected to the source terminal of the transistor Q₃ and with a first terminal of the capacitor C₃, a resistor R₂ and diodes D₃ and D₄. The high voltage control integrated circuit 12 further connects in the middle of the connection of the source terminal of the transistor Q₃ and a first terminal of the resistor R₁, individually to a capacitor C₂, and in the middle of the interconnection of the inductor L₂ and capacitor C₁. The capacitor C₂ and the inductor L₂ are serially interconnected. The inductor L₂ is further connected to the capacitor C₃.

A capacitor C₁ is on a first side connected between a diode D₅ and the drain terminal of transistor Q₂, and on the second side between diodes D₃, D₄ and the resistor R₁. A drain terminal of the PNP transistor Q₁ is connected in the middle of the inductor L₁ and the diode D₅ and the source terminal of the transistor Q₁ is connected to a resistor R₂, which is also connected in the middle of the diodes D₃ and D₄, and the capacitor C₁. A power factor controller unit 14 is connected to the inductor L₁, the gate of the transistor Q₁, in the middle of the connection of the source terminal of transistor Q₁ and resistor R₂, and in the middle of the connection of diode D₅ and capacitor C₁.

In this configuration the resonant capacitance is strongly load dependent. This dependence with respect to 0 to 4 lamp combinations is shown in FIG. 2a, where five distinct resonant frequency curves are charted on a voltage/frequency chart. Here, the zero lamp curve 20 represents a scenario in which no lamps are connected, the one lamp curve 22 represents a scenario in which one lamp is connected, the two lamp curve 24 represents a scenario in which two lamps are connected, the three lamp curve 26 represents a scenario in which three lamps are connected, and finally the four lamp curve 28 represents a scenario in which four lamps are connected. The respective frequency peaks of the curves 22, 24, 26 and 28 are 9.554215×10⁴, 7.52929×10⁴, 6.503028×10⁴, and 5.843909×10⁴.

FIG. 2b shows the same five distinct resonant frequency curves, charted on a primary side resonant tank input phase/frequency chart. In this graph, the zero lamp curve 30 reaches a low phase point of −90, the one lamp curve 32 reaches a low phase point of −23.360583, the two lamp curve 34 reaches a low phase point of −14.71952, and the three lamp curve 36 reaches a low phase point of −5.566823.

Traditionally, the power feedback power factor correction circuits are limited to a fixed load operation. When the load changes, the input line power factor and current THD performance drop. Even more severe situation is that the DC bus voltage increases dramatically as the load decreases. Such DC bus voltage over boost usually leads to the damage of power switches if they are not substantially over designed. This problem is encountered during the development of a power feedback circuit for four lamp ballast circuits.

In view of those variables and the sinusoidal input voltage, it would be advantageous to have a simple single stage electronic ballast circuit based on the power feedback scheme for multiple lamp operation.

### SUMMARY OF THE INVENTION

The ballast circuit of the invention is designed for a single or multiple lamp parallel operation, where at each lamp a condition may be controlled such that the amplitude output voltage are almost constant in the steady state. The present invention uses fewer high ripple current rated capacitors than the prior art while providing galvanic isolation. Furthermore, in addition to using smaller input filter sizes, the inventive circuit uses fewer fast reverse recovery diodes necessary for the prior art circuit schemes.

In order for the inventive power feedback circuit to work with multiple lamp combinations under variable load conditions and without severe DC bus voltage over boost, the resonant tank is designed with an LLC type instead of the previously used LC type. Accordingly, the circuit switching frequency is changed for each lamp number condition. When a lamp number condition is settled, the circuit operates at a selected frequency without line frequency modulation content.

The circuit of the invention comprises a DC storage capacitor, a DC blocking capacitor, a half-bridge of power transistors which alternatively switch on and off and having 50% duty ratio, and an LLC resonant converter having a resonant inductor, a output transformer, and one or more effective resonant capacitors. The circuit comprises an output transformer, which provides galvanic isolation for a double path type power feedback scheme. The output transformer produces magnetizing inductance utilized for power feedback circuit optimization and is inserted right after the resonant inductor of the half-bridge circuit.

Furthermore, the circuit of the invention comprises an input line filter having an inductor and a capacitor for bringing an input current close to a sinusoidal waveform with low THD, a current rectifier comprising a plurality of diodes, a plurality of fast reverse recovery diodes, and a plurality of ballasting capacitors that contribute to a resonant capacitance and allows the use of fewer capacitors in the half-bridge circuit.

### BRIEF DESCRIPTION OF DRAWINGS

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is a schematic representation of parallel connection of multiple lamps via ballasting capacitors of the prior art, where resonant capacitance is strongly load dependent.

FIG. 2a is a chart showing voltage/frequency dependence for each of zero to four lamp combinations.

FIG. 2b is a primary side resonant tank input phase/frequency chart showing the dependence with respect to zero to four lamp combinations.

FIG. 3 is a schematic representation of the inventive ballast circuit.

FIG. 4 is a schematic representation of a simplified version of the inventive ballast circuit adapted for equivalent circuit load.

FIG. 5 is a schematic representation of a prior art circuit adapted for a single lamp application.

FIG. 6 is a schematic representation of another prior art circuit adapted for a single lamp application.

FIGS. 7a, b and c are each a schematic representation of an equivalent inventive circuit where the amplitude of the resonant inductor current and the output voltage are almost constant in the steady state.

FIGS. 8-11 are input and output voltage/frequency oscilloscope waveform charts for typical inventive circuit, showing the dependence with respect to one, two, three and four lamps.

FIG. 12 is a voltage, current/time oscilloscope waveform charts showing a set of switching waveforms of the inventive circuit shown in FIG. 4 with respect to eight intervals depicted in FIGS. 13a-h.

FIGS. 13a-h are each a schematic representation of an equivalent inventive circuit where the amplitude of the resonant inductor current and the output voltage vary in accordance with time intervals.

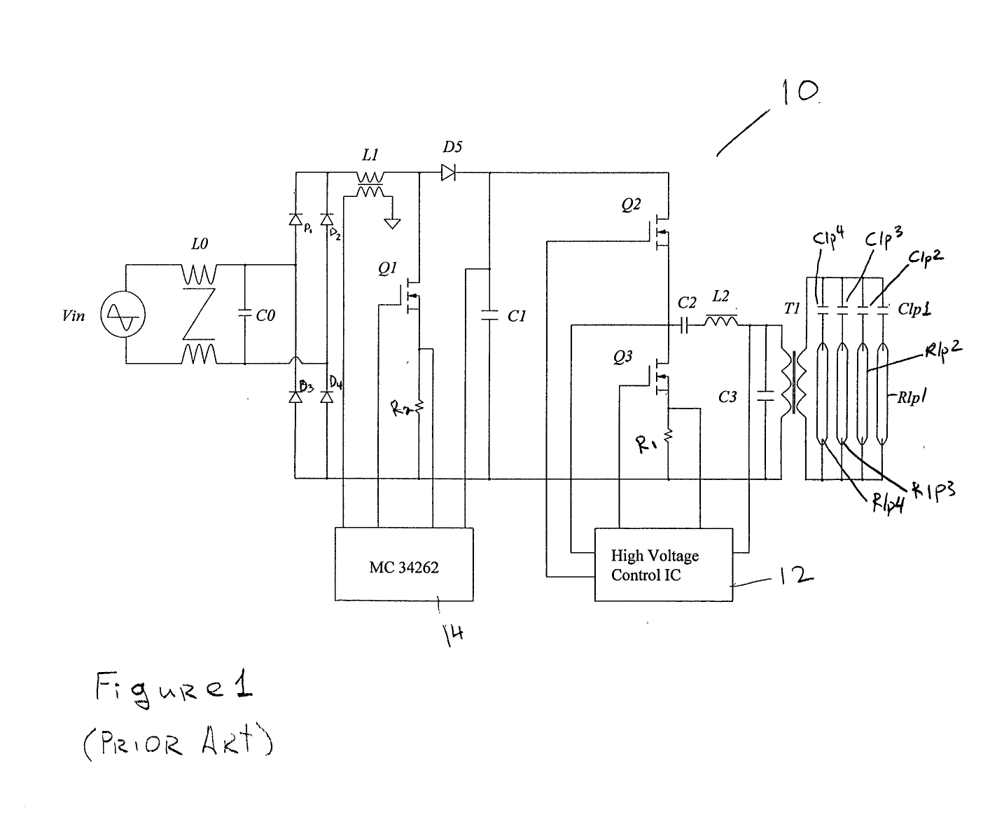

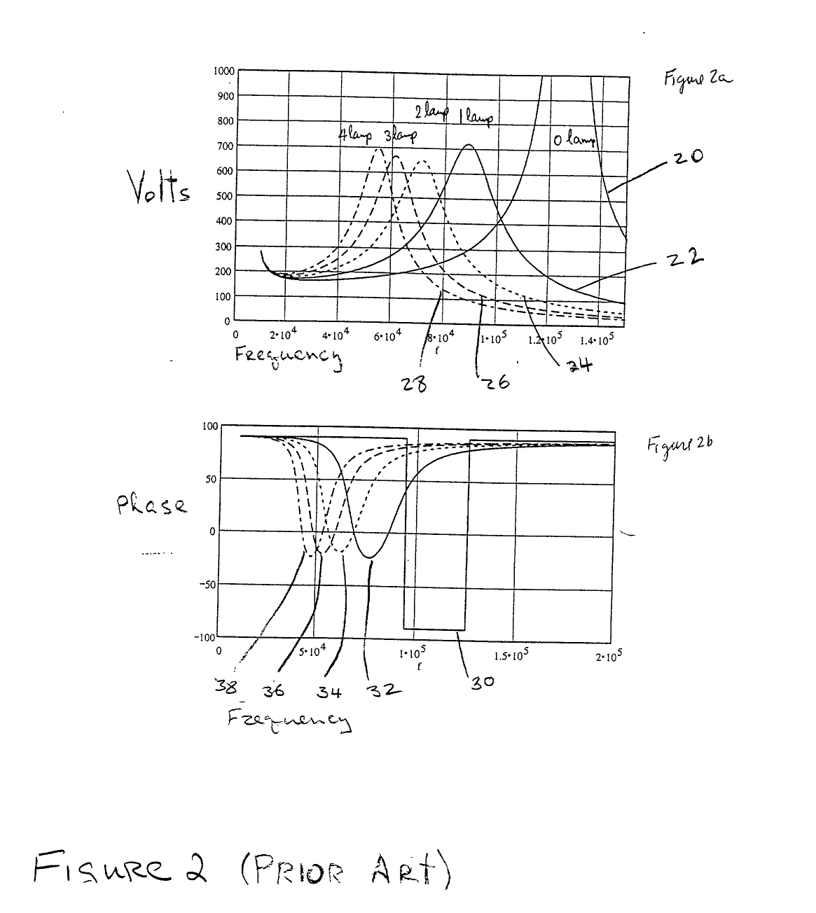

### DETAILED DESCRIPTION OF THE INVENTION

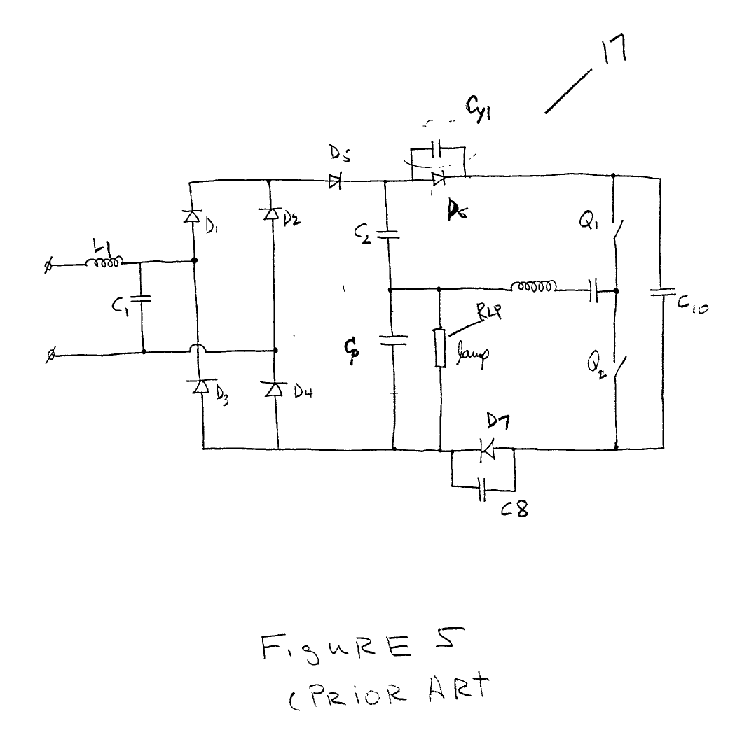

FIG. 3 shows the ballast circuit 40 of the present invention. The input terminal 44 of the circuit 40 is connected to a resonant inductor L₁, which is connected between diodes D₃ and D₁ of the full-bridge rectifier, represented by diodes D₁-D₄. A capacitor C₁ is connected between the resonant inductor L₁ and that inductor's connection to diodes D₃ and D₁, and to the output terminal 46. The output terminal 46 further connects between diodes D₄ and D₂. Diodes D₁, D₂ are connected to a diode D₅, which is connected to a diode D₆. The diode D₆ is in turn connected to a capacitor C₁₀ that is connected to a resonant sink circuit 42.

The resonant sink circuit 42 comprises the transformer T₁ connected on one side to inductor L₂, which in turn is connected to a capacitor C₃, which is connected to the transistor Q₂. The transistor Q₂ connects to the diode D₇, which connects to the second terminal of the transformer T₁. A capacitor C₂ is connected between diodes D₅ and D₆ on one side and between the transformer T₁ and the inductor L₂ on the other side. A transistor Q₁ is connected to between the diode D₆ and the capacitor C₁₀ on one side and the capacitor C₃ and the transistor Q₂ on the other side. A capacitor C₈ is connected to each terminal of the diode D₇. Each lamp Rₗₚ of the multi lamp unit 46 is connected in parallel to capacitors C₄-C₇, and the lamp unit is then connected to the transformer T₁. Finally, the terminal of the transformer T₁ that is connected to the diode D₇ is also connected to diodes D₃, D₄.

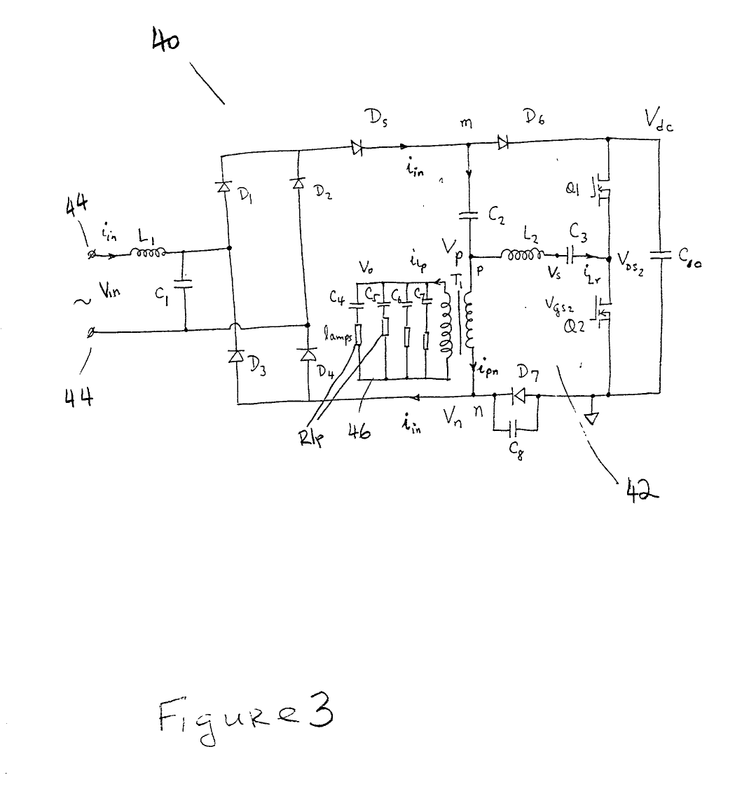

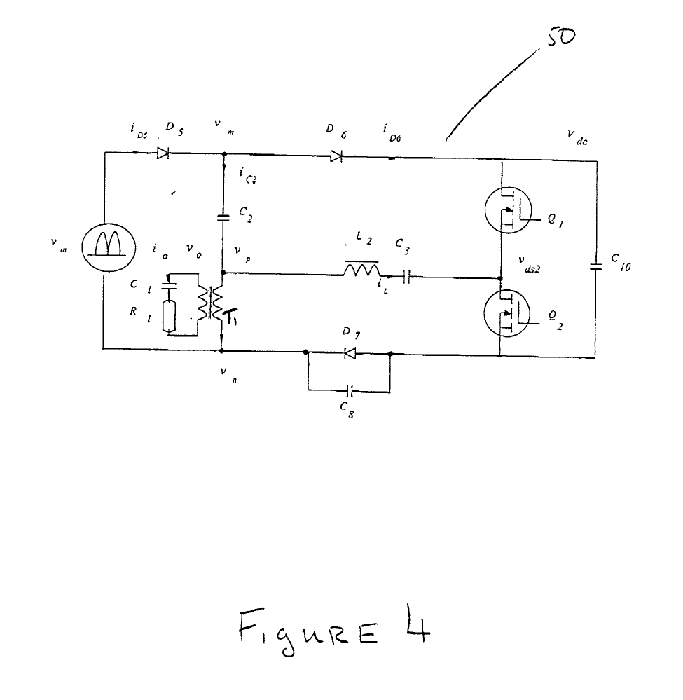

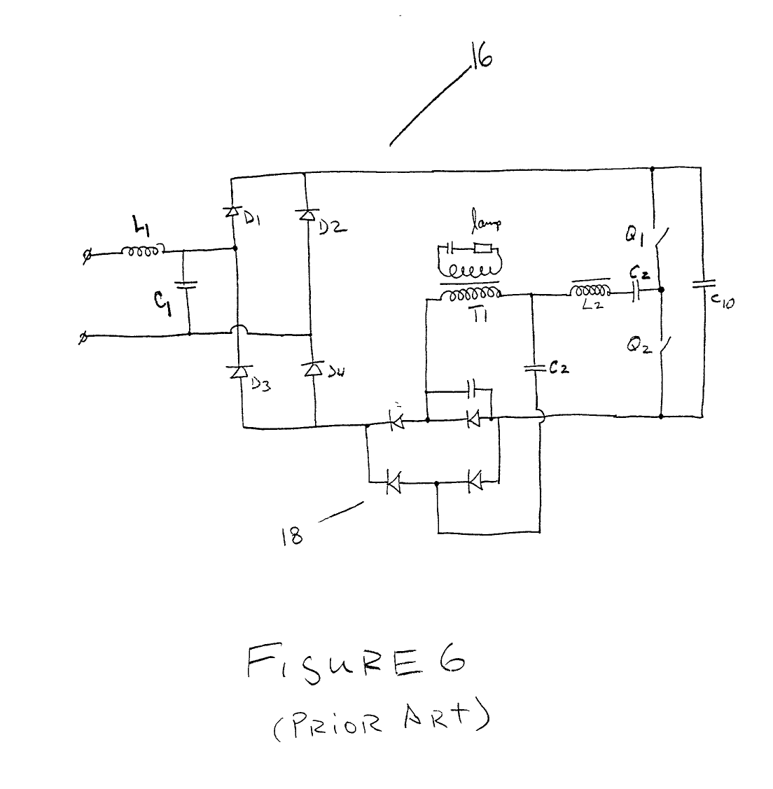

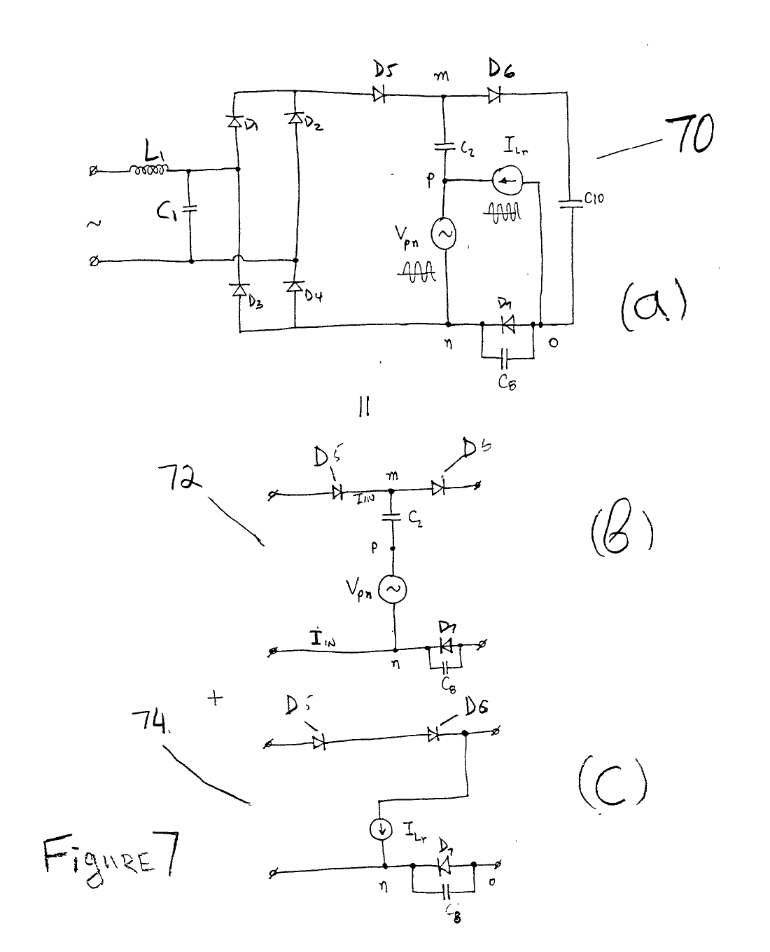

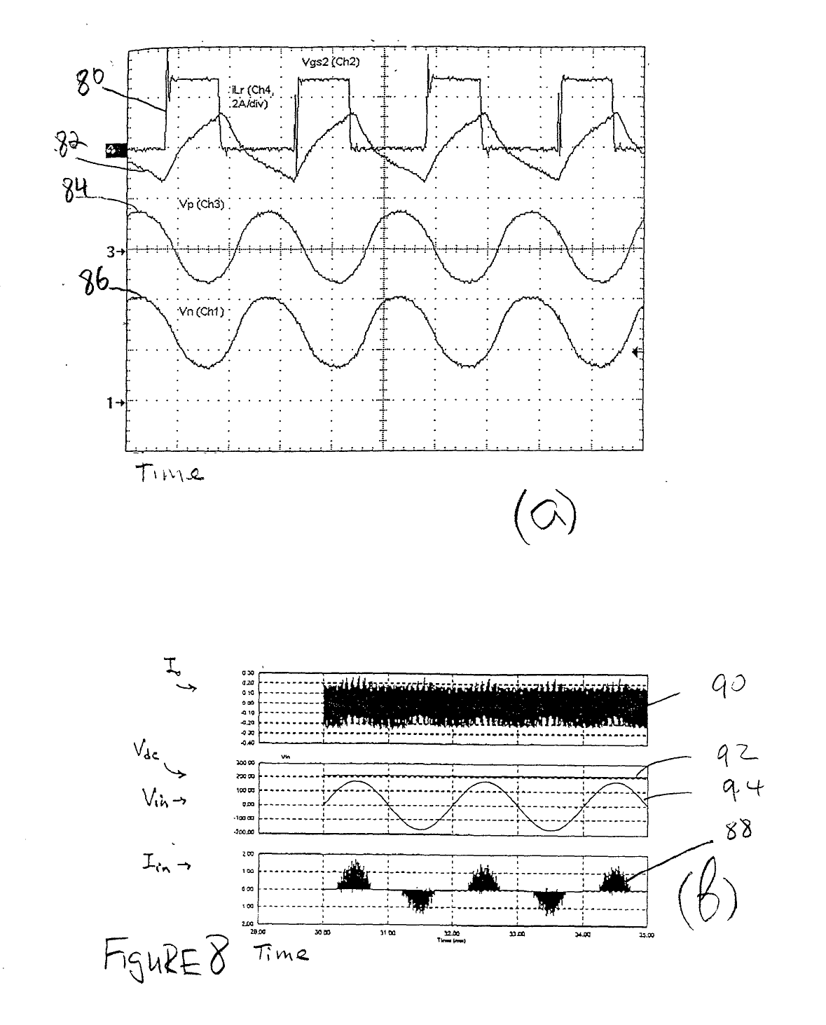

The simplified version of the circuit 40 adapted for the single lamp application is shown in FIG. 4 and will be described below. The circuit 40 of the present invention uses fewer high ripple current rated capacitors than the prior art circuits shown in FIGS. 5 and 6, while providing galvanic isolation. One resonant inductor is contributed by the magnetizing inductance of the input transformer. By doing so, there is no need for an additional resonant inductor other than L₂ (FIG. 3). With a properly designed LLC type resonant tank, the lamp current crest factor is improved without using the C_{y1} (FIG. 5) which must be used in the prior art circuit 17 (FIG. 5). Because the lamp ballasting capacitor C₁ may also act as a part of resonant capacitor, Cₚ (FIG. 2) can also be removed. Furthermore, in addition to using smaller input filter sizes, the inventive circuit uses fewer fast reverse recovery diodes 18 (FIG. 6) necessary for the prior art circuit schemes, e.g., circuit 16 (FIG. 6). More importantly, the inventive circuit may be used for 4-lamp operation.

With reference to FIG. 3, to achieve the above benefits the inverter circuit 40 includes a half-bridge with a LLC resonant converter. The half-bridge includes two power Metal-Oxide-Silicon Field-Effect Transistors (MOSFETs) Q₁ and Q₂, the DC storage capacitor C₁₀ and the DC blocking capacitor C₃. One resonant inductor is L₂. The resonant capacitors include capacitors C₂, C₈, and the equivalent capacitance of that circuit reflected by the load. The galvanic isolation transformer T₁ is disposed between the resonant inductor L₂ and the diode D₇ to create a proper load matching.

Additionally, the magnetizing inductance of the isolation transformer contributes to the resonant tank with additional inductance. The difference between a single path type power feedback scheme and a double path type power feedback scheme is that in each high frequency switching cycle the full-bridge rectifier, represented by diodes D₁-D₄, conducts once for the single path type and twice for the double path type power feedback scheme. For the same power delivery capability, the double path type power feedback scheme has fewer current stresses in the resonant tank circuit 42.

The resonant components are designed to set the resonant frequencies under certain operation conditions for each of the load cases. In order to achieve ILO, the voltage gain curves should reach and exceed certain required voltage levels, which are preferred to be kept almost constant at the output terminal 46 via proper control. The invention further employs fast reverse recovery diodes D₅-D₇.

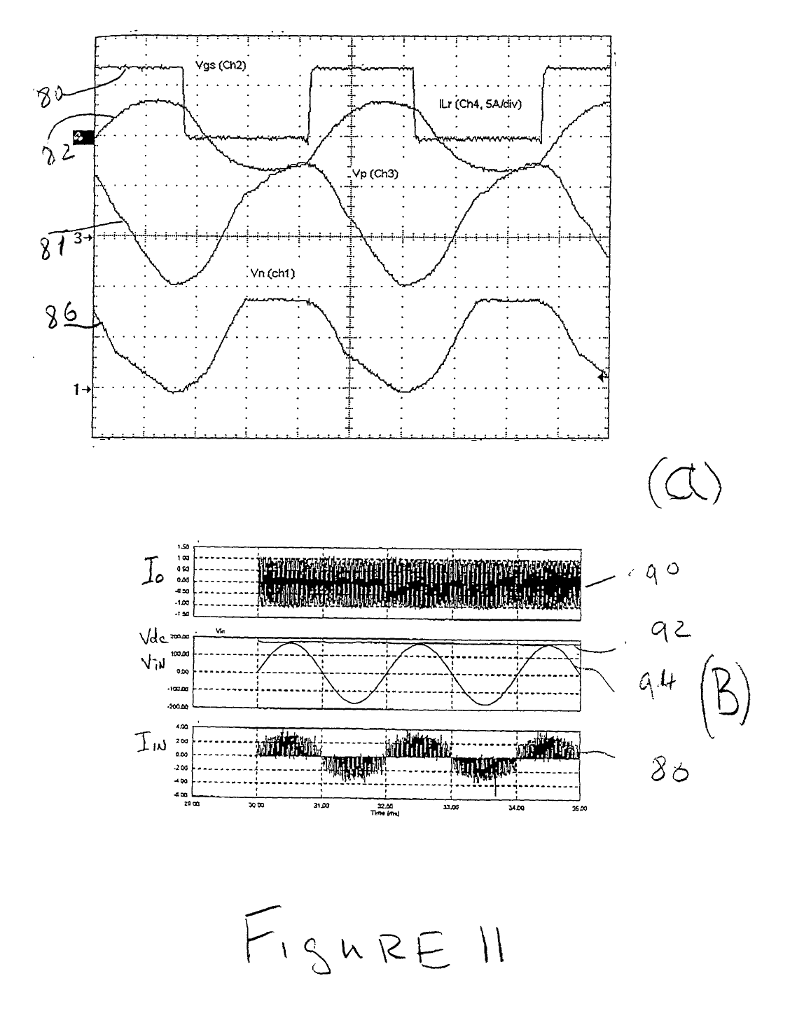

FIG. 8a shows a square waveform curve 80 of voltage V_{gs} (FIG. 3) used to drive the lower power switch Q₂ (FIG. 3). By alternatively switching power switches Q₁ (FIG. 3) and Q₂ (FIG. 3) on and off with 50% duty ratio, the voltage Vₛ (FIG. 3) has a peak-to-peak amplitude V_{dc} (FIG. 3). Such voltage excites the resonant tank circuit 42 (FIG. 3) and results in the input current i_{Lr}(t) 15 (FIG. 3) represented by the i_{Lr} curve 82. Due to the resonant tank circuit 42 (FIG. 3), the Vₚ curve 84 of voltage Vₚ (FIG. 3) at point p (FIG. 3) and the Vₙ curve 86 of voltage Vₙ (FIG. 3) at point n (FIG. 3) are close to the sinusoidal waveform. Furthermore at each of the plurality of lamps, e.g., 1, 2, 3 and 4, a condition may be controlled such that the amplitude of the resonant inductor current i_{Lr}(t) and the output voltage Vₒ(t) (FIG. 3) are almost constant in the steady state.

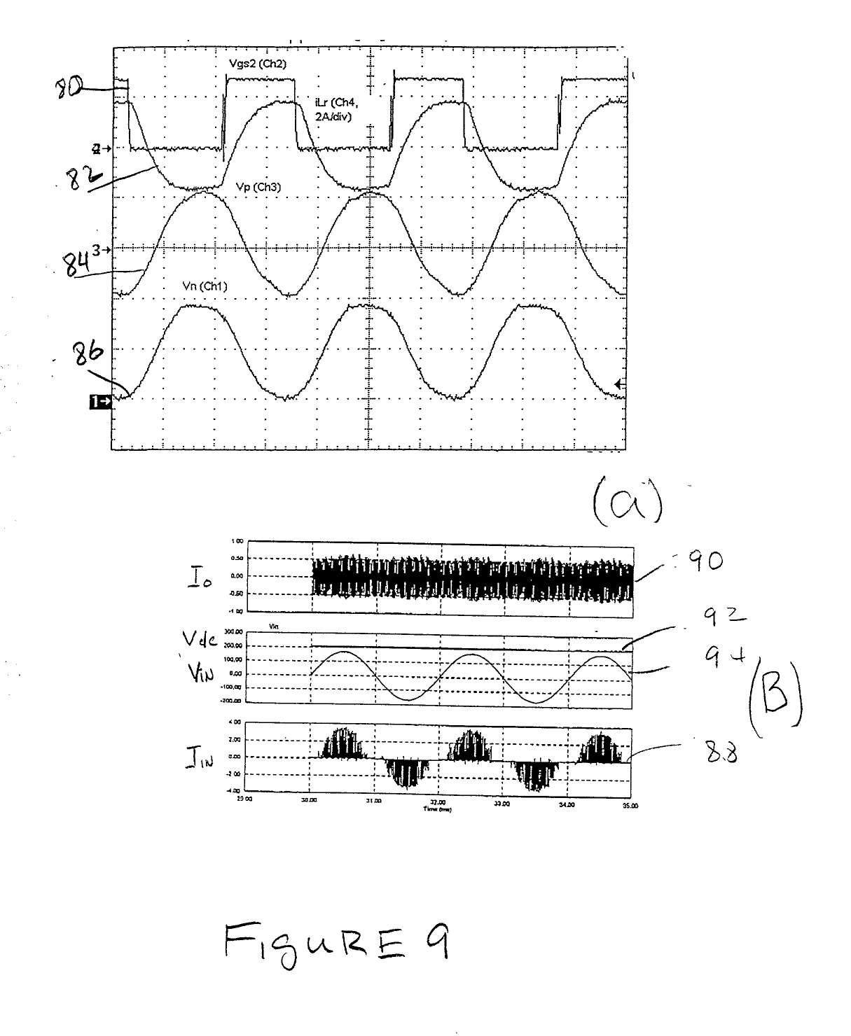

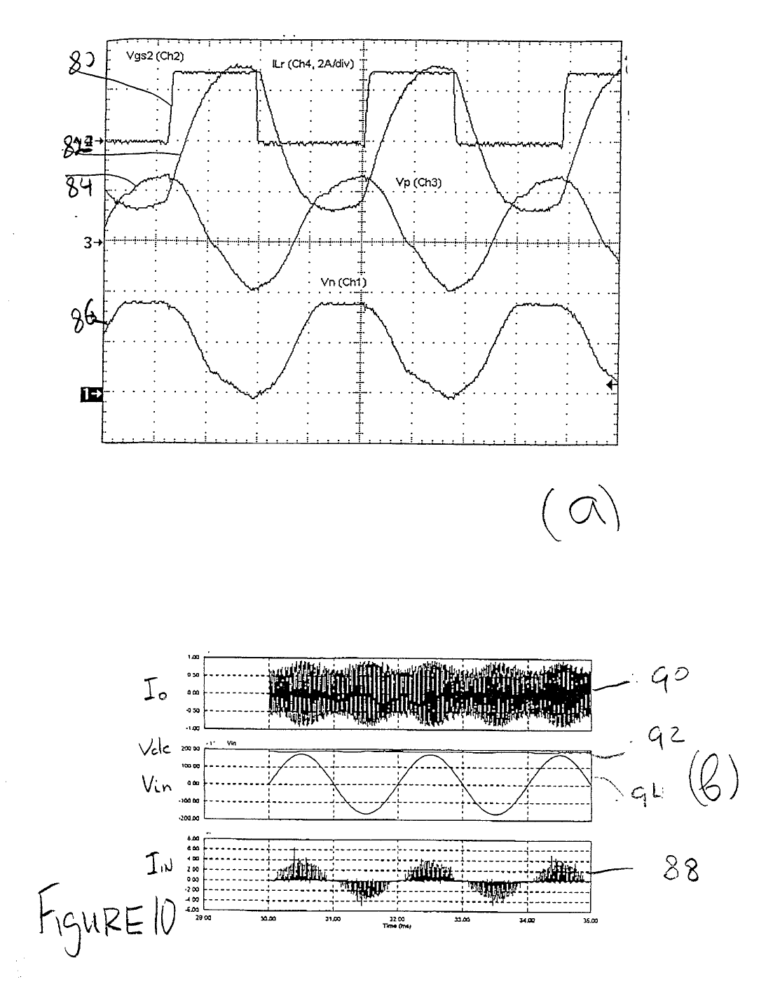

With this condition, the high frequency operation of the inventive circuit may be described by components of an equivalent circuit as shown in FIGS. 7a. In that circuit the resonant inductor current is modeled as an ideal current source I_{Lr} and the output voltage is reflected to the primary side and modeled as an ideal voltage source Vₚₙ. Further, the power feedback circuit 70 can be decomposed into two simpler power feedback circuits 72 and 74 (FIGS. 7b, c). In the first, high frequency circuit 72 (FIG. 7b), as compared to the input line frequency, the voltage source Vₚₙ modulates the voltage at point m via the charging capacitor C₂. This modulation causes the input current iᵢₙ(t) (FIG. 7b) to be sinusoidaly shaped as represented by the curve 88 (FIG. 8b).

In the second circuit 74 (FIG. 7c), the current source Iₗᵣ 15 charges/discharges the capacitor C₈ and shares the input current accordingly. It is important to note that there is a phase difference between the signals Vₚₙ(t) and I_{Lr}(t). It is this phase difference that allows the rectifier circuit D₁-D₄ to conduct current twice, makes the circuit 70 the double path type power feedback circuit. In each high frequency cycle, the double path type power feedback circuit 70 generates two small current pulses in the input line. The envelope of these small pulses follows a pseudo-sinusoidal shape. By using proper input line filter, for example the inductor L₁ and the capacitor C₁, the input current will become close to the sinusoidal waveform with a low THD, as represented by the curve 88 (FIG. 8b).

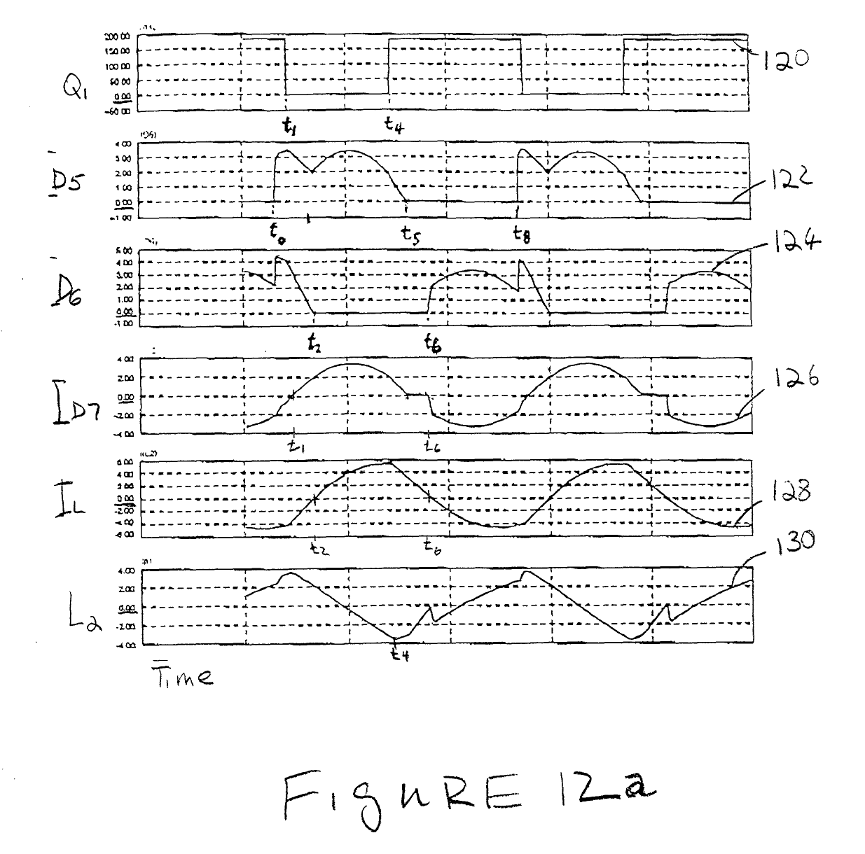

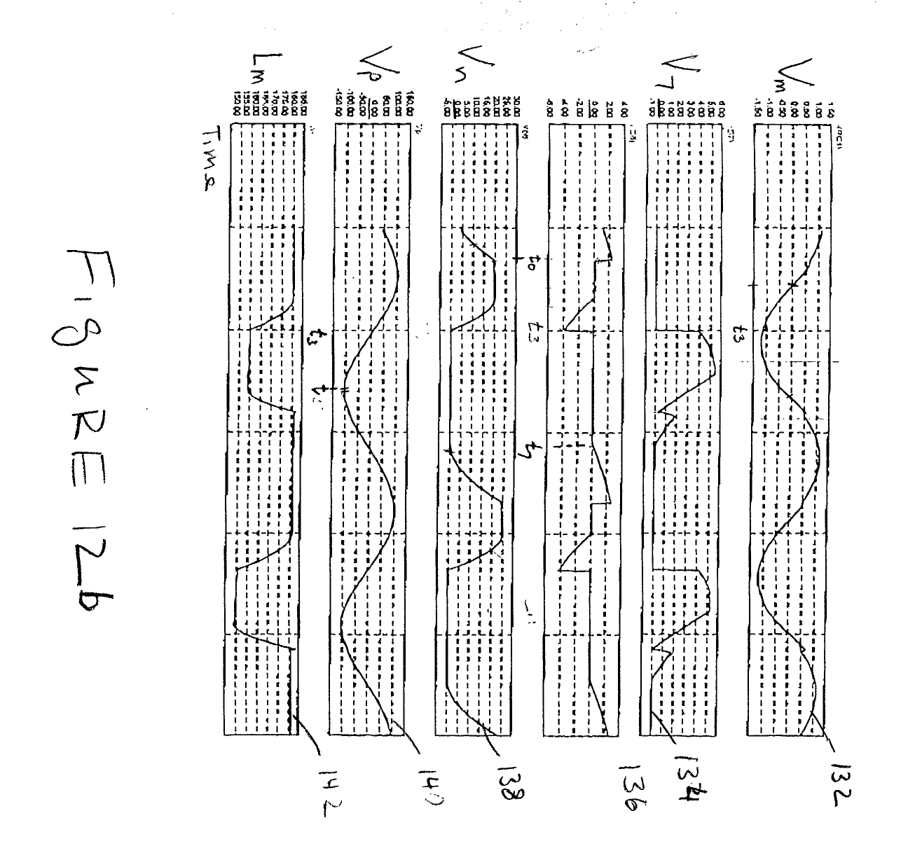

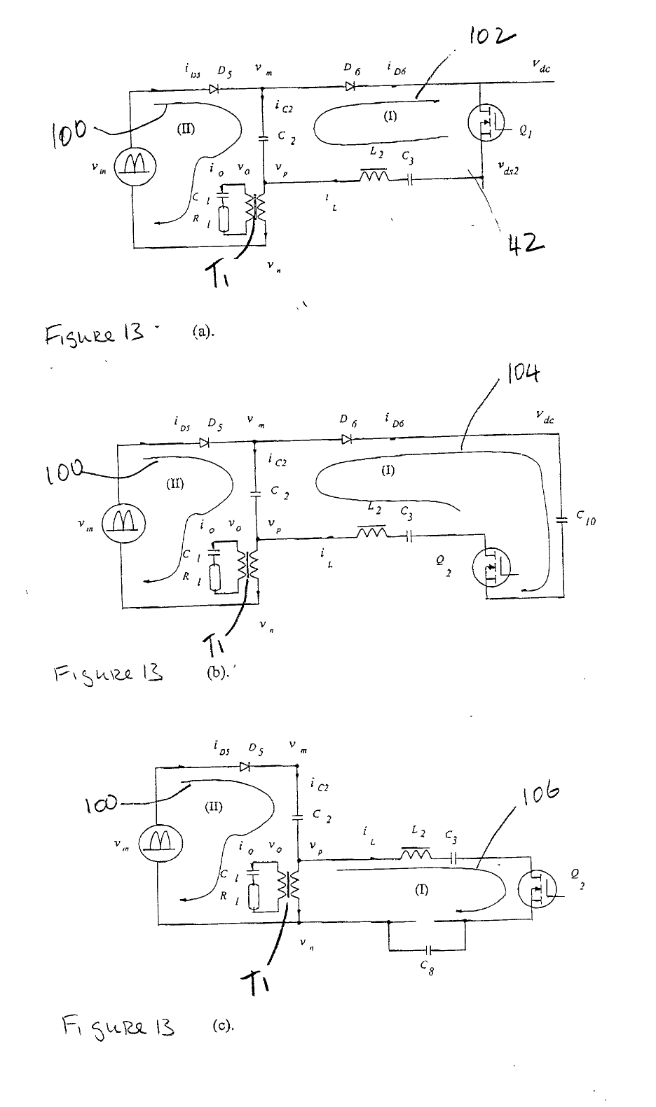

FIGS. 8-11 show the high frequency oscilloscope waveform curves representing voltages at different points in the circuit 40 (FIG. 3). Specifically, FIGS. 8a, 9a, 10a, and 11a show the following waveform curves for the one, two, three, and four lamp configurations respectively:

1. The gate drive waveform curve 80 showing V_{gs2}(t) for the switch Q₂ (FIG. 3);

2. The resonant inductor current curve 82 for the current i_{Lr}(t) (FIG. 3);

3. The voltage waveform curve 84 for voltage Vₚ(t) at point p 16 (FIG. 3), and

4. The voltage waveform curve 86 for voltage Vₙ(t) at point n (FIG. 3)

Similarly, FIGS. 8b, 9b, 10b, and 11b show the waveform curves 88 for the input line current Iᵢₙ (FIG. 3); 90 for the output lamp current Iₗₐₘₚ (FIG. 3); 92 for the input voltage Vᵢₙ (FIG. 3); and 94 for the voltage V_{dc} (FIG. 3), in a low frequency scale for the one, two, three, and four lamp configurations respectively.

As a further explanation, with reference to FIG. 4, please consider the following functional description of a specific simplified embodiment circuit 50 of the present invention. By varying values of R₁ and C₁, all four lamp load states may be accounted for. For example, if R₁ and C₁ denote the equivalent impedance of one lamp and its associated ballasted capacitance, then for n-number of lamps the equivalent impedance becomes Rₗ/n and the equivalent series ballasting capacitance becomes n_{Cl}.

The input line voltage Vᵢₙ is a rectified sinusoidal waveform. Because the line frequency, e.g., 60 Hz, is much lower than the circuit switching frequency, e.g., 43 kHz, the input line voltage Vᵢₙ is assumed to be constant in high frequency cycles. Furthermore, a DC bus voltage ripple may be ignored due to the large capacitance of C₁₀. With above assumptions, eight equivalent topological stages in each high frequency switching cycle may now be identified.

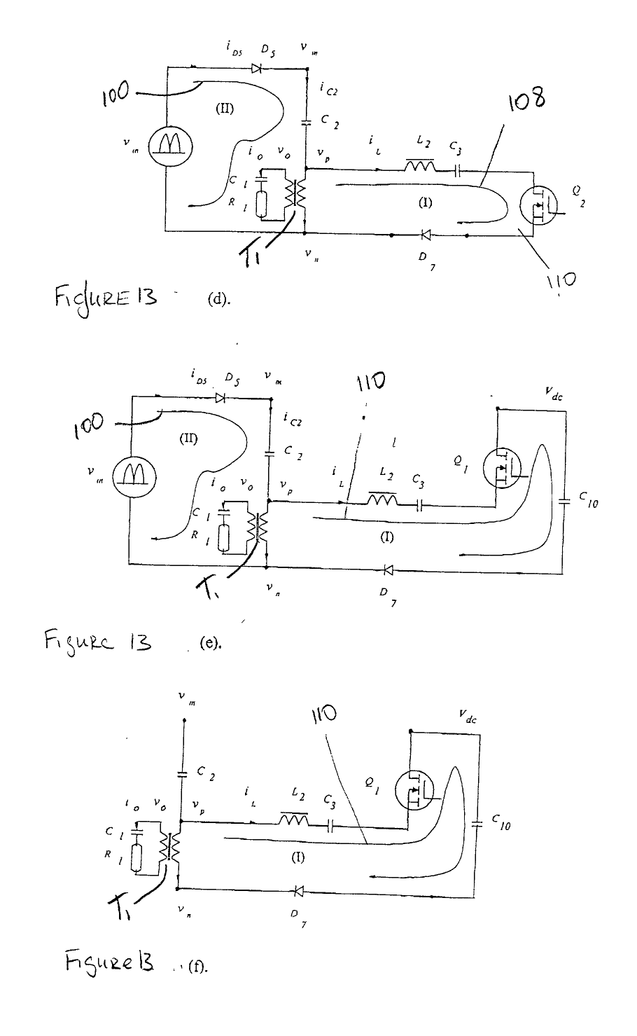

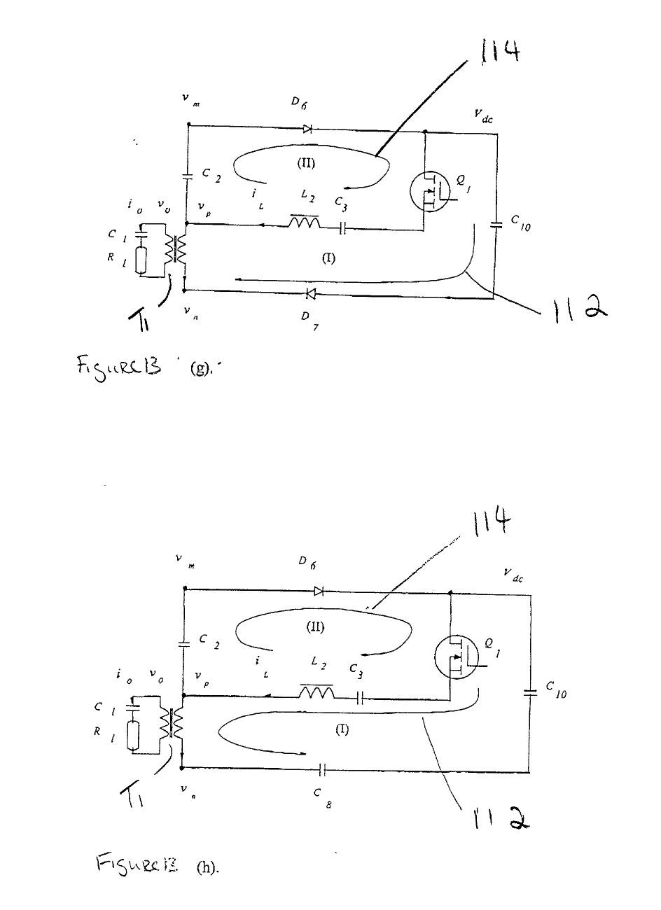

Switching waveforms of the circuit 50 having eight equivalent topological stages corresponding to time intervals [tⱼ, t₍ⱼ₊₁₎], where j=0, . . . , 7, are presented in FIG. 12. These equivalent topological stages are discussed below with the aid of FIGS. 13a-h. FIG. 13a shows the equivalent circuit during the first interval [t₀, t₁]. Starting from t₀, both diodes D₅ and D₆ conduct current I_{d5} and I_{d6}, as shown by graphs 92 and 94 (FIG. 12) respectively, however no charging current reaches the capacitor C₁₀ (FIG. 4) because diode D₇ (FIG. 4) is off Moreover, the capacitor C₈ (FIG. 4) is prevented from being further charged. During that interval, the line voltage source Vᵢₙ delivers power directly to the load via loop II 100, while the resonant tank circuit 42 operates in a free wheeling mode in loop I 102. The current in the capacitor C₂ is the difference between the resonant tank 42 current i_{L} in loop I 102 shown as a graph 98 (FIG. 12) and the input line current i_{D5} in loop II 100 shown as a graph 98 (FIG. 12).

While the current i_{L} is still in free wheeling state with the current direction indicated by loop I 102, the MOSFET Q₁ is turned off 90 (FIG. 12a), as shown in FIG. 13b, during the interval [t₁, t₂], and the current is diverted to the MOSFET Q₂. Please note that the MOSFET Q₂ may be turned on with zero voltage switching. With the charging of the DC bulk capacitor C₁₀ via loop I 104, the current i_{L} in the resonant inductor L₂, shown as the graph 98 (FIG. 12), gradually diminishes to zero. When the zero point is reached, diode D₆ is naturally turned off 94 (FIG. 12) and the second interval [t₁, t₂] terminates.

Following the switch off 94 (FIG. 12) of the diode D₆ during the third interval [t₂, t₃] shown in FIG. 13c, the resonant inductor current i_{L}, shown as the graph 98 (FIG. 12), indicated by loop I 106, reverses direction and increases with the discharging of the capacitor C₈. During this interval, along with further discharging of the capacitor C₈, the voltage Vₚ continuously drops, as shown by a graph 250 (FIG. 12). This drop is followed by continuous charging of the capacitor C₂ while the line voltage source Vᵢₙ delivers power directly to the load.

After the voltage Vₙ across the capacitor C₈ drops to zero 248 (FIG. 12), as is shown in FIG. 13d, the diode D₇ begins conducting current. During this, fourth interval [t₃, t₄], the resonant tank 42 current I_{L}, shown as the graph 98 (FIG. 12), in loop I 108 is further increased with the resonant frequency shown as a graph 240 (FIG. 12) determined by the inductor L₂, the capacitor C₈ (FIG. 4), the capacitor C₁, and the resistor R₁, turns ratio n and the magnetizing inductance Lₘ of the output transformer. In the meantime, the current in the diode D₅ starts decreasing from its peak value, that is because voltage Vₚ falls below zero, as shown in the graph 250 (FIG. 12) and goes in to a negative swing.

FIG. 13e shows the resonant tank current I_{L} flowing in loop I 110 during the fifth interval [t₄, t₅]. At t₄, the MOSFET Q₂ is switched off. During this interval, the MOSFET Q₁ is turned on, as shown as a graph 120 (FIG. 12a), which may be achieved with zero voltage switching (ZVS). As time reaches t₅, the voltage Vₚ reaches its minimum value, as shown in the graph 140 (FIG. 12b) and the input current I_{D5} approaches zero, as shown in a graph 122 (FIG. 12a). With the upswing of the voltage Vₚ, as shown in the graph 140 (FIG. 12b), the voltage Vₘ increases correspondingly, as shown in the graph 132 (FIG. 12b), because C₂ is not being charged or discharged. At the same, as shown in FIG. 13f, during the sixth time interval [t₅, t₆], the resonant inductor current I_{L} is reduced to zero, as shown in the graph 128 (FIG. 12a), and the diode D₇ stops conducting.

When the voltage Vₘ, as shown in the graph 132 (FIG. 12b), is greater than the voltage V_{dc}, during the seventh interval [t₆, t₇] as shown in FIG. 13g, the diode D₆ begins conducting current, as shown in the graph 124 (FIG. 12a),. Momentarily, the diode D₇ is switched on to help the voltage Vₘ to charge the capacitor C₁₀ via loop I 112. At the same time the capacitor C₂ begins discharging to transfer the energy stored in the capacitor C₂ into the resonant inductor current i_{L}, i.e., the electromagnetic energy. The current i_{L} is then gradually built up from zero, as shown in the graph 128 (FIG. 12a).

While the capacitor C₂ is continuously discharging via loop II 114, during eighth interval [t₇, t₈], shown in FIG. 13h, the capacitor C₈ begins to charge via the loop I 112 with the DC bus capacitor C₁₀ providing the charging current through a load branch. As a result, the voltage Vₚ increases, as shown in the graph 140 (FIG. 12b), and the voltage Vₘ is kept greater than V_{dc}, as shown in the graph 132 (FIG. 12b).

While the equivalent circuit 50 (FIG. 4) holds true for each operating point of the sinusoidal input line voltage, the waveforms in FIGS. 12a, 12b and operating intervals in FIGS. 13a-h are shown for one typical operating point which may be around ₈₀% of the input line peak voltage. At other operating points, the duration of each interval and even the number of intervals may vary; however, the circuit operating principles will remain the same. In each high frequency switching cycle from to to t₈, there are two sections [t₀, t₂] and [t₂, t₅], where the circuit draws two current pulses from the line. The peak value of the pulses is low compared with a single pulse case of single path power feedback schemes. As a result, the resonant tank current is smaller and the associated losses are also smaller.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

Having thus described our invention, what we claim as new, and desire to secure by Letters Patent is:

1. A ballast circuit for a parallel operation of at least one lamp, each of said at least one lamp having a ballasting capacitor, said circuit operating in high frequency cycles, said circuit comprising:
one or more power transistors to generate a resonant inductor current;
a LLC resonant converter comprising a resonant inductor, an output transformer having magnetizing inductance, and at least one resonant capacitor, a part of said LLC resonant converter forming a resonant tank circuit for generating a first voltage;
said output transformer providing galvanic isolation for generating a second voltage, said resonant inductor being disposed between said output transformer on its first side and said one resonant capacitor on its second; and
said at least one lamp having a third voltage via said ballasting capacitor.

2. The circuit of claim 1, wherein a condition is controlled such that amplitudes of said third voltage are held constant in a steady state for said one or more lamps.

3. The circuit of claim 2, further comprising a first capacitor, whereby said resonant inductor current charges and discharges said first capacitor.

4. The circuit of claim 3, wherein a phase difference exists between said second voltage and said resonant inductor current.

5. The circuit of claim 4, wherein a condition is controlled such that an amplitude of said resonant inductor current and said third voltage are constant in said steady state for said one or more lamps.

6. The circuit of claim 5, wherein in each of said high frequency cycles, said circuit conducts current twice.

7. The circuit of claim 6, wherein said power transistors generate said resonant inductor current by alternatively switching on and off, said power transistors having 50% duty ratio.

8. The circuit of claim 6, wherein said output transformer produces magnetizing inductance.

9. The circuit of claim 8, further comprising a power feedback circuit, whereby said magnetizing inductance is utilized to optimize said power feedback circuit.

10. The circuit of claim 9, further comprising:
an input line filter having an inductor and a capacitor, said input line filter filters an input current to approach a sinusoidal waveform with a low THD;
a current rectifying circuit comprising a plurality of diodes;
a plurality of fast reverse recovery diodes; and
a DC storage capacitor and a DC blocking capacitor.

11. The circuit of claim 10, wherein said power feedback circuit of said resonant tank produces in said input current a power factor unique for differing number of lamps.

12. The circuit of claim 11, wherein a fourth voltage of said resonant tank is under 220.

13. The circuit of claim 12, wherein said circuit is operated at a first frequency where for each of said differing number of lamps a fourth voltage is kept under 220 Volts.

14. The circuit of claim 13, wherein for each of said differing number of lamps, an operating frequency is kept constant without line frequency modulation.

15. A ballast circuit for a parallel operation of multiple lamps, each of the lamps having a ballasting capacitor, said circuit comprising:
a power feedback circuit; and
a LLC resonant converter comprising a resonant inductor connected on one side to an output transformer having magnetizing inductance, and connected on the other side to at least one resonant capacitor, a part of said LLC resonant converter forming a resonant tank circuit for generating a first voltage, said resonant tank circuit allowing said power feedback circuit to produce reasonable power factor in said input current of the ballast circuit for differing number of said multiple lamps and keeping a DC bus voltage under 220 Volts for said differing number of said multiple lamps.
